(19) United States
(12) Patent Application Publication
(10) Pub. No.: US 2003/0059099 A1
(43) Pub. Date: Mar. 27, 2003

(54) Optical character recognition system

(75) Inventor: Naofumi Tateishi, Toronto (CA)

Correspondence Address: SMART AND BIGGAR, 438 UNIVERSITY AVENUE, SUITE 1500 BOX 111, TORONTO, ON, M5G2K8, CA

(73) Assignee: Longford Equipment International Limited

(21) Appl. No.: 09/963,532

(22) Filed: Sep. 27, 2001

(51) Int. Cl. G06K 9/18

(52) U.S. Cl. 382/139

(57) ABSTRACT

To recognise characters in a character set developed for magnetic ink character recognition (MICR), the characters are optically imaged as a matrix of pixels. Pixel values in each of a plurality of adjacent parallel lines of pixels in the matrix are then summed to obtain a line total for each line. The lines of pixels may be chosen to parallel a height dimension of the characters in order to eliminate skew. Thus, in the absence of skew, the lines will simply be columns of the matrix of pixels. Line totals may be compared with line total templates. Each line total template is characteristic of a character in the character set.

This invention relates to a method, apparatus, and computer readable medium for optically recognising characters in a character set developed for magnetic ink character recognition (MICR).

### BACKGROUND OF THE INVENTION

Bank cheques, traveller's cheques and certain other financial documents typically include a string of characters printed with magnetic ink. This allows recognition of such characters by a magnetic ink recognition (MICR) system. In an MICR system, a charging head may be passed over characters printed with a magnetic ink in order to temporarily magnetise them. Next a magnetic read head may be passed sequentially over the characters to produce analog signals representative of each character.

Certain character sets have been developed to facilitate MICR. One such character set, which is commonly used in Europe, is the CMC-7 character set defined in Official French Standard no. NF Z63-001 (1964). Another, which is commonly used in North America, is the E13B character set defined in the American National Standards Institute (ANSI) specification no. X9.27-2000. There are fourteen distinct characters in the E13B character set (the numbers 0 to 9 as well as four special characters: “Amount”; “On-Us”; “Transit” and “Dash”).

MICR systems typically allow character recognition with less processing than is required with optical recognition systems. Another advantage of an MICR system over an optical recognition system is that characters may be recognised even if there is a low contrast between the characters and their surroundings. Low contrast may occur when MICR characters are written over or where the background colour of the financial document is similar to the ink colour of the characters. On the other hand, MICR systems typically require that documents be conveyed past the magnetic read head of the system at a constant speed. Further, the analog signals developed by the magnetic read head inherently provides less information than optical signals and, hence, are susceptible to providing less accurate character recognition. Therefore, there have been attempts to develop optical recognition systems which may function with character sets developed for magnetic recognition.

U.S. Pat. No. 5,091,968 to Higgins et al. describes an optical character recognition system suitable for recognising a character set developed for magnetic recognition. In Higgins, an optical read head scans a document in consecutive sweeps to develop a pixelated image of the document. A window is positioned to frame each character, the pixels in the framed character are binarised, and the result compared with templates for characters in the character set.

A need remains for an optical character recognition system suitable for recognising a character set developed for magnetic recognition which has relatively low processing requirements.

### SUMMARY OF INVENTION

In the subject invention, characters in a character set developed for magnetic ink character recognition (MICR) are optically captured as a matrix of pixels. Pixel values in each of a plurality of adjacent parallel lines of pixels in the matrix are then summed to obtain a line total for each line. Line totals may be then used in character recognition. For example, line totals may be compared with line totals templates where each line totals template is characteristic of a character in the character set. Or difference totals may be obtained from pairs of adjacent line totals and the difference totals compared with difference totals templates.

The subject invention therefore takes the quantised information available in the matrix of pixels and produces a quantised array of line totals or line totals differences. Array values in an array of line totals differences are substantially proportional to values that would be obtained by sampling an analog signal derived from a magnetic read head of common MICR systems. Thus, the subject invention provides an optical approach which may be similar in result to common magnetic approaches thereby providing an optical approach suited to reading character sets developed for MICR.

Accordingly, the present invention provides a method of recognising characters in a character set developed for magnetic ink character recognition (MICR), comprising: optically imaging one or more characters of said character set as a matrix of pixels; summing pixel values in each of a plurality of adjacent parallel lines of pixels in said matrix to obtain a line total for each said line; and using line totals in recognising said one or more characters.

According to another aspect of the invention, there is provided apparatus for use in recognising characters in a character set developed for magnetic ink character recognition (MICR), comprising: an optical read head for optically imaging one or more characters in said character set as a matrix of pixels; a memory for storing templates; a processor for: summing pixel values in each of a plurality of adjacent parallel lines of pixels in said matrix to obtain an array of line totals for said plurality of lines; and using said array in recognising said one or more characters.

According to a further aspect of the invention, there is provided a computer readable medium which, when loaded into a computer causes said computer, when said computer stores an image of one or more characters in a character set developed for magnetic ink character recognition (MICR) as a matrix of pixels, to: sum pixel values in each of a plurality of adjacent parallel lines of pixels of said matrix to obtain an array of line totals for said plurality of lines; and use said array of line totals in recognising said one or more characters.

### BRIEF DESCRIPTION OF THE DRAWINGS

In the figures which illustrated an example embodiment of the invention,

FIG. 1 is an optical character recognition system made in accordance with this invention,

FIG. 2 illustrates a sample character of the E13B character set and some associated information,

FIGS. 3a and 3b illustrate tables of characteristic values for characters of the E13B character set, and

FIG. 4 is a flow diagram illustrating the operation of the system of FIG. 1.

### DETAILED DESCRIPTION

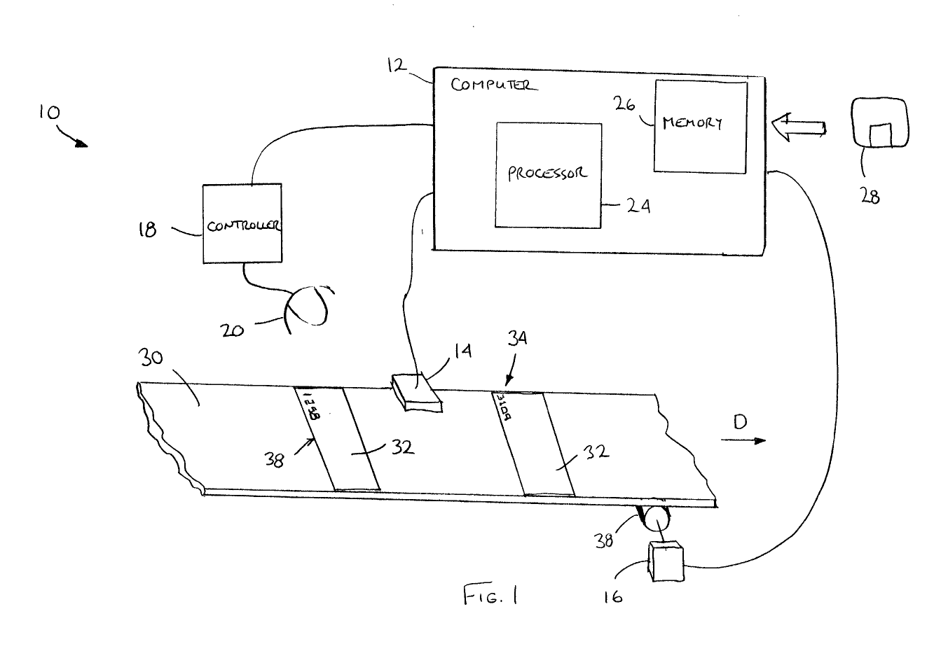

Turning to FIG. 1, a system 10 for optically recognising characters in a character set developed for MICR comprises a computer 12 connected for communication with an optical reader 14, a speed indicator 16, and a controller 18 for a strobe light 20. The computer has a processor 24 and a memory 26. The computer is loaded with software from computer readable medium 28 which, for example, may be a diskette, a CD-ROM, a non-volatile memory chip, or a file downloaded from a remote source. The optical reader images a scene in its field of view as a matrix of pixels. The optical reader may, for example, be a charge coupled device (CCD) or CMOS imaging device. A conveyor 30 conveys cheques or other documents 32 printed with a line 34 of magnetic ink characters in a character set developed for MICR in a downstream direction D past optical reader 14. A roller 38 rotates with movement of conveyor 30 and provides a conveyor speed input to speed indicator 16.

Assuming that the document 32 is a bank cheque, the cheque will have a MICR Clear Band extending along its bottom edge. The MICR line 34 of MICR characters lies within the MICR Clear Band. For U.S. cheques, the MICR line is approximately 3/16″ (1.01 mm) above the bottom edge of the cheque.

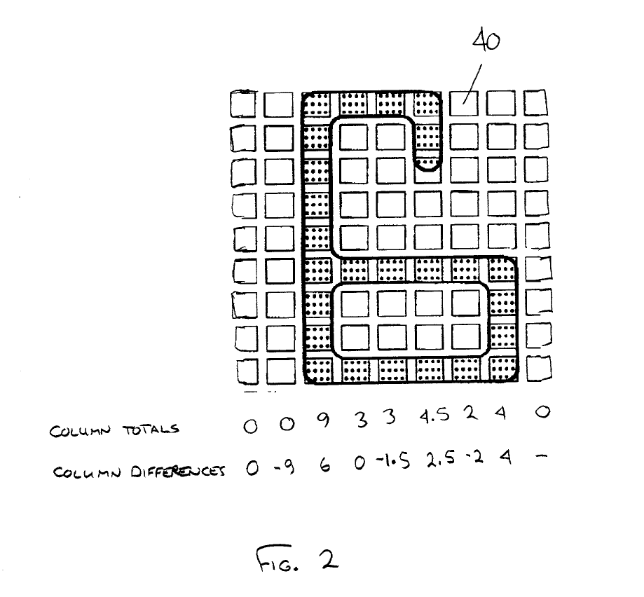

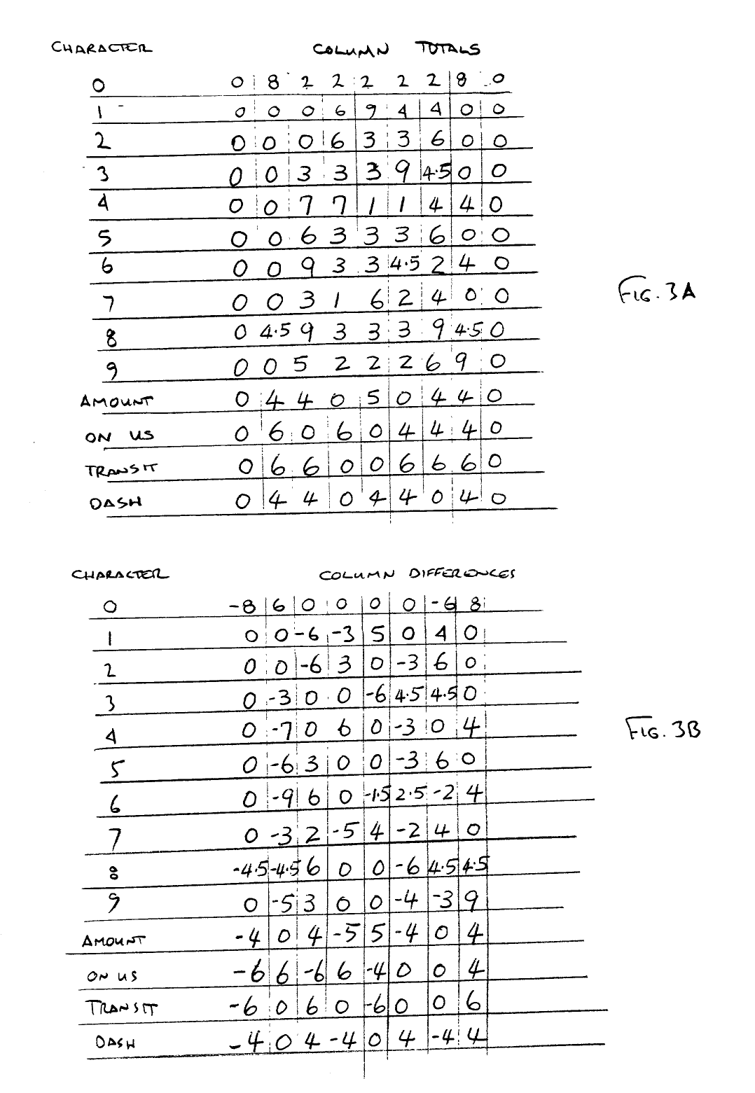

Each of the characters in the E13B character set was designed based on a 9×9 matrix of squares of size 0.013″ (0.330 mm). Each character is specified to be, at a maximum, seven squares wide, such that at least the leading and trailing column of squares is empty. The characters also have a specified shape. This suggests that for characters complying with the specifications of the character set, each column of squares will have a specific number of squares filled with ink. This is illustrated in FIG. 2 which shows a character “6” drawn in accordance with the E13B character set and superimposed on the 9×9 matrix of squares 40 from which it was derived. Aligned below each column is an indication of the “Column Totals”, i.e., the number of squares of each column which are filled with ink. The “Column Totals” represent an integral. Another characteristic of each character will be the “Column Differences”, i.e., the number of squares of a given column which are filled with ink less the number of squares of the next adjacent column which are filled with ink. The “Column Differences”, which represent a derivative, are also shown for the character “6”. The “Column Totals” and “Column Differences” characteristic of each character in the E13B character set are shown in FIGS. 3a and 3b, respectively.

In view of the (0.013″ or 0.330 mm) size of the squares of the 9×9 design matrix, the design matrix is 0.117″ square (2.97 mm square). According to the specification for the E13B character set, the distance from the leading edge of one character to the leading edge of the next character in the set is to be 0.125″+/−0.010″ (3.175 mm+/−0.254 mm).

Returning to FIG. 1, often (though not necessarily) the MICR line 34 will be about 4″ (10.2 mm) in length. If the MICR line 34 is printed in accordance with the E13B character set, the 0.125″ (3.175 mm) spacing from the leading edge of one character to the leading edge of the next character means that, a 4″ long MICR line would comprise thirty-two character positions. If the optical reader 14 is a CCD with a standard resolution of 640×480 pixels, the image between the leading edge of one character and the leading edge of an adjacent character is then (680/32 =) twenty pixels wide. Given that the design matrix for E13B characters is 0.117″ (2.97 mm) square and that 0.125″ provides a resolution of twenty pixels, the 9×9 design matrix of squares (of size 0.013″) is covered by a 19×19 matrix of pixels.

To prepare system 10 for operation, a template is formed for each character in the E13B character set. This may be accomplished by considering the nine column totals (of FIG. 3a) which characterise each character to be a nine element array and then scaling up this array to comprise nineteen elements. Each nineteen element array becomes a template. Alternatively, E13B characters meeting nominal specifications may be dilated to fit a 19×19 matrix and then column totals taken from these 19×19 matrices to provide nineteen element template arrays. These templates are stored in computer 12.

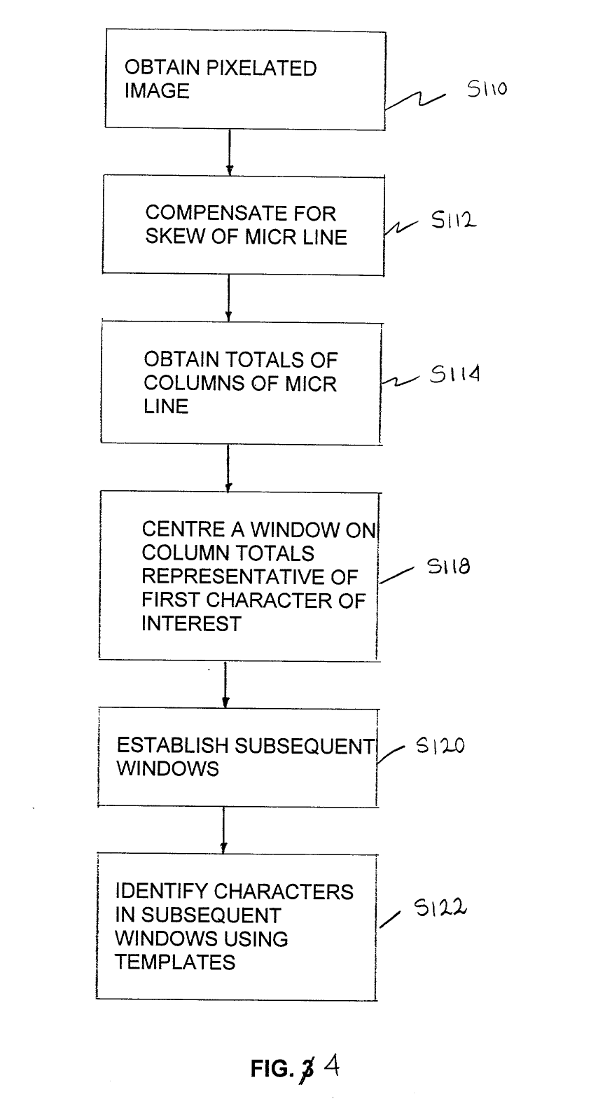

The operation of the system of FIG. 1 is described in conjunction with FIG. 4. Documents 32 may be placed in a pre-defined orientation at pre-defined locations on conveyor 30. In consequence, computer 12, having a conveyor speed input from speed sensor 16, can determine when a MICR line 34 passes under optical reader 14. When this occurs, computer 12 may prompt controller 18 to pulse strobe 20. This causes the strobe to highly illuminate the document 32 under the optical reader thereby enhancing the contrast between the characters of the MICR line on the document 32 and the background for these characters as well as other indicia on the document. The computer prompts the reader 14 to store a pixelated image while the strobe is illuminating the document 32 and to upload this image (S110).

It should be noted that system 10 functions even when conveyor 30 moves at variable speeds. All that is required is appropriate timing to allow an image to be stored when the MICR line on the document are under the optical read head. This contrasts to an MICR system with an analog magnetic read head which requires a constant speed conveyor for proper operation.

It will be apparent from FIG. 1 that each document 32, and its MICR line 34, is oriented on conveyor 30 so that its length dimension is perpendicular to downstream direction D. This is possible because of the optical imaging of the characters in the MICR line. This contrasts to a MICR system with an analog magnetic read head which requires that the documents be transported with their length dimension, and the length dimension of their MICR lines, parallel to the downstream direction D so that the characters are serially presented to the read head. The perpendicular orientation of documents 32 in system 10 allows higher speed operation than a system with an analog read head.

It will be noted that since the MICR line on a cheque is typically about 3/16″ (4.76 mm) above the bottom edge of the cheque, the 480 pixels of a 640×480 CCD may readily capture the bottom edge of the cheque to beyond the top of the characters.

The computer determines whether there is any document skew by considering the imaged bottom edge of the document. If there is no skew, the columns of the CCD matrix of the read head should be aligned with the height dimension of the characters of the MICR line 34. In this instance, the computer may choose a nineteen pixel high band of pixels paralleling the image of the bottom edge of the cheque and spaced 3/16″ from it. This band should capture the image of the MICR line. If there is skew, the computer will choose an appropriate (nineteen pixel high) band of pixels as representing the imaged MICR line 34 to compensate for this skew (S112). The skew compensating band will comprise parallel lines of pixels which, though not aligned with the columns of the CCD matrix of the read head, are aligned with the height dimension of the characters. If the computer is unable to minimize skew to a pre-defined tolerance, the computer may produce an error signal in respect of the processing of the particular document. If the computer is successful in obtaining a suitable band of pixels representing the imaged MICR line, it may then binarise the pixels in the nineteen pixel high band. Typically, a pixel in a CCD may have 256 greyscale values, with a zero value representing white and a value of 255 representing black. The pixels of each pixel matrix may be binarised by comparison with a threshold value such that values less than 125 are assigned a “0” value and values over 125 are assigned a “1” value. The computer then sums the binarised values in each column of the band to an array of column totals (S114).

The computer must next locate the first character of interest. For instance, it may be that it is desired to read the routing transit number in the transit field of the MICR line on the cheque. This number will be delimited by a pair of Transit characters. It will be recalled that there are twenty pixels between the leading edges of adjacent characters in the MICR line. Thus, there will be a twenty wide sub-array in the array of column totals for each character in the MICR line. Consequently, the computer tries to centre a twenty wide window of column totals on the leading one of this pair of characters (S118). To do so, the computer makes a guess for the positioning of the first window and then compares the twenty column totals for this window with the (nineteen element wide) template for the Transit character (in each of the two possible positions which the nineteen element wide template has within the twenty element wide window). If there is no match, the computer moves the first window along by one or more column total positions and tries again. This process is repeated until the window column totals match the template for the Transit character confirming that the first window is centered on this character.

The computer then forms a series of adjacent windows twenty columns wide extending from the first window (S120) and compares the twenty column totals of each subsequent window against character templates, each template being associated with one character in the character set (S122). The window is then recognised as containing the character whose window column total template mostly closely matches the series of column totals from the window. This continues until the last character of interest is recognised (in this case, the trailing one of the pair of Transit characters).

Use of column totals in character recognition allows a cross-check of the characters recognised, as follows. The totals representative of a character provide an indication of the quantity of ink in each character. With standard MICR characters, there is (within a tolerance) a set quantity of ink used in forming each character. Thus, in system 10, the quantity of ink indicated by the column totals of a recognised character may be compared with that of a previously recognised character to determine whether the ratio in the quantities of ink used meet the expected ratio to within a threshold. If no, an error indication may be generated.

While the system 10 has been described in conjunction with an optical reader 14 having a resolution of 640×480 pixels, a head having a different resolution could be used. For example, the resolution could be doubled if each window were segmented so as to provide columns which are two pixels wide. In such instance, all pixels in a segmented column would be summed to obtain the window column total for the segmented column. These window column totals could then be compared with the aforedescribed character templates. Alternatively, any resolution head could be used with character templates that were re-determined accordingly. Furthermore, since the width of a character in pixels will also vary if the field of view of the read head changes to capture more or less than thirty-two characters, a different character width in pixels is also accommodated by an appropriate re-determination of the character templates.

Optionally, instead of binarising pixels in the MICR line, the grey-scale value (e.g., 158) of a pixel may be taken as the value for that pixel such that the column total will comprise a weighted average of the grey scale values. In this instance, optionally, a grey-scale value over a certain threshold (e.g., 231) may be re-set to the maximum grey scale value (of 255) and a grey-scale value under a certain minimum threshold (e.g., 25) may be re-set to the minimum grey-scale value (of 0). In this way, the system will better discriminate characters printed on non-white backgrounds.

As a further option, each character template may comprise an array of column differences rather than column totals. The column difference templates may be formed by considering the eight difference totals of FIG. 3b which characterises each character to be an eight element array. These arrays are then scaled by a factor which depends upon the resolution of characters by the optical read head. Alternatively, the column difference templates may be derived from the column totals which result after appropriate dilation of E13B characters meeting nominal specifications. With difference array templates, operation of system 10 proceeds as before, however, an array of differences is obtained from the column totals representative of the imaged MICR line 34 and computer 12 windows this difference array.

Optionally, instead of the strobe 20 strobing when prompted by computer 12, the strobe may strobe on receipt of a prompt directly from conveyor 30. Such a prompt could comprise a microswitch associated with the probe which is actuated by protuberances on conveyor 30. Similarly, optical reader 14 may be prompted to store and forward an image to computer 12 when the microswitch is actuated. In such a modified system, there is no need for speed indicator 16. As a further option, the strobe 20 and its controller 18 may be replaced by a continuously illuminated source, such as a light emitting diode. The optical reader could then be prompted to store and forward an image by computer 12 (prompted by the speed indicator) or by a microswitch.

It will be appreciated that even without the image of the bottom edge of the cheque, determination of the orientation of the MICR line with respect to the optical read head may be possible. Even if not, it may be sufficient to trust that the placement of documents on conveyor 30 avoids skew. In such case, the computer assumes the columns of pixels imaged by the CCD parallel the height dimension of the characters of the MICR line 34. Where skew will not be a problem, or may be compensated for by processing, only the MICR line (and not the bottom of the document) needs to be imaged. In this case, the resolution of the CCD may be lower. Indeed, since the characters of the E13B character set are designed around a 9×9 matrix with the leading and trailing columns empty, a window matrix as small as 7×9 could be used to discriminate between the characters. With an optical read head having a small resolution, consecutive images are arranged by the computer into the image of the MICR line.

Other modifications will be apparent to those skilled in the art and, therefore, the invention is defined in the claims.

What is claimed is:

1. A method of recognising characters in a character set developed for magnetic ink character recognition (MICR), comprising:
optically imaging one or more characters of said character set as a matrix of pixels;
summing pixel values in each of a plurality of adjacent parallel lines of pixels in said matrix to obtain a line total for each said line; and
using line totals in recognising said one or more characters.

2. The method of claim 1 wherein said using line totals in recognising characters comprises comparing line totals with line totals templates.

3. The method of claim 1 wherein said using line totals in recognising characters comprises obtaining differences between adjacent pairs of line totals.

4. The method of claim 3 further comprising comparing said differences with differences templates.

5. The method of claim 1 wherein each said line is chosen so as to parallel a height dimension of said one or more characters.

6. The method of claim 1 further comprising optically imaging an edge of a document on which said characters are printed and wherein said lines are chosen to have a pre-determined orientation with respect to said document edge whereby skew may be reduced.

7. The method of claim 1 wherein each said line of pixels is one pixel wide.

8. The method of claim 1 wherein each said line of pixels is more than one pixel wide.

9. The method of claim 1 wherein said line totals comprise an array and wherein said using further comprises forming a window around a sub-array of said line totals, a size of said window based on a pre-defined spacing of characters in said character set.

10. The method of claim 9 wherein said using further comprises comparing said sub-array of line totals, or a function of said sub-array of totals, with one or more character template arrays.

11. The method of claim 1 further comprising transporting a document on which said characters are printed in a direction parallel to a height dimension of said characters.

12. The method of claim 1 wherein said character set developed for MICR comprises a set of E13B characters.

13. A method of recognising characters in a character set developed for magnetic ink character recognition (MICR), comprising:
optically imaging one or more characters of said character set as a matrix of pixels;
summing pixel values in each of a plurality of adjacent columns of said matrix to obtain an array of column totals for said plurality of columns; and
using said array of column totals in recognising said one or more characters.

14. Apparatus for use in recognising characters in a character set developed for magnetic ink character recognition (MICR), comprising:
an optical read head for optically imaging one or more characters in said character set as a matrix of pixels;
a memory for storing templates;
a processor for:
summing pixel values in each of a plurality of adjacent parallel lines of pixels in said matrix to obtain an array of line totals for said plurality of lines; and
using said array in recognising said one or more characters.

15. The apparatus of claim 14 wherein said optical read head is a charge coupled device (CCD).

16. The apparatus of claim 14 wherein said optical read head is a CMOS imaging device.

17. The apparatus of claim 14 further comprising a conveyor arranged for conveying a document on which said characters are printed in a direction parallel to a height dimension of said characters.

18. A computer readable medium which, when loaded into a computer causes said computer, when said computer stores an image of one or more characters in a character set developed for magnetic ink character recognition (MICR) as a matrix of pixels, to:
sum pixel values in each of a plurality of adjacent parallel lines of pixels of said matrix to obtain an array of line totals for said plurality of lines; and
use said array of line totals in recognising said one or more characters.

19. The computer readable medium of claim 18 wherein said computer readable medium further causes said computer to load a series of line total templates prior to comparing said array of line totals.
